(19) United States
(12) Patent Application Publication
(10) Pub. No.: US 2024/0408998 A1
(43) Pub. Date: Dec. 12, 2024

(54) CHARGING SYSTEM CAPABLE OF DYNAMIC POWER DISTRIBUTION, AND METHOD, APPARATUS, MASTER CHARGING PILE AND MEDIUM

(71) Applicant: Autel Digital Power Co., Ltd., Shenzhen (CN)

(72) Inventors: Lin MA, Shenzhen (CN); Yin HUANG, Shenzhen (CN); Wenjian WANG, Shenzhen (CN); Baicheng FU, Shenzhen (CN); Quan XIONG, Shenzhen (CN)

(73) Assignee: Autel Digital Power Co., Ltd., Shenzhen, GD (CN)

(21) Appl. No.: 18/806,678

(22) Filed: Aug. 15, 2024

Related U.S. Application Data
(63) Continuation of application No. PCT/CN2023/073689, filed on Jan. 29, 2023.

(30) Foreign Application Priority Data
Feb. 16, 2022 (CN) 202210151389.4

(51) Int. Cl. B60L 53/68; B60L 53/63; B60L 53/64; B60L 53/67; G06Q 30/0283; G06Q 50/06

(52) U.S. Cl. CPC B60L 53/68; B60L 53/63; B60L 53/64; B60L 53/67; G06Q 30/0283; G06Q 50/06

(57) ABSTRACT

Provided is a charging system, including at least one group of charging sets, where each charging set includes a master charging pile and a plurality of slave charging piles, and the master charging pile is respectively connected to the plurality of slave charging piles; and a cloud server, where the cloud server is configured to be in a communication connection with the master charging pile in the at least one group of charging sets; and the master charging pile is connected to a power distribution controller of a power grid and is configured to acquire a power parameter from the power distribution controller, to determine a distributable power for each charging set. The problem of not being able to calculate a charging power in the case of network disconnection may be solved; moreover, a configuration may be updated when a network is connected.

### CROSS-REFERENCE TO RELATED APPLICATIONS

This application is a continuation application of International Patent Application No. PCT/CN2023/073689 filed on Jan. 29, 2023, which claims priority to Chinese Patent Application No. 202210151389.4, entitled “CHARGING SYSTEM CAPABLE OF DYNAMIC POWER DISTRIBUTION, AND METHOD, APPARATUS, MASTER CHARGING PILE AND MEDIUM”, filed on Feb. 16, 2022, the entire disclosures of which are incorporated herein by reference for all purposes.

### TECHNICAL FIELD

Embodiments of the present disclosure relate to the technical field of charging piles, and in particular, to a charging system capable of dynamic power distribution, a method, an apparatus, a master charging pile and a medium.

### BACKGROUND

With the popularity of electric vehicles, the number of electric vehicle charging piles is increasing. The electric vehicle charging piles belong to high-power electrical equipment, therefore, the access of the charging piles will cause great pressure to the power distribution system of power grid, especially in the small power grid, or when the charging piles are installed in the household power grid, the problem of overload operation will often occur due to the excessive power of the charging piles, which will lead to fuse failure due to overload in the local power grid.

In implementing the embodiments of the present disclosure, the inventors of the present disclosure found that: when the cloud is used to control the charging piles centrally, all the charging pile information is transmitted to the cloud server via the network; the charging pile also transmits its own power grid capacity and instant electricity consumption information to the cloud, and then the cloud distributes data uniformly, and sends the distribution result to the charging pile, and the charging pile executes the distributed charging instruction to charge; however, this method is excessively dependent on the cloud, and the local information security of the charging pile is not high; once the charging pile and the cloud are disconnected from the network, the charging power cannot be calculated, resulting in poor reliability.

### SUMMARY

It is an objective of embodiments of the present disclosure to provide a charging system capable of dynamic power distribution, a method, an apparatus, a master charging pile and a medium, which can solve the problem of not being able to calculate a charging power in the case of network disconnection; moreover, a configuration can be updated when a network is connected.

In order to solve at least the above-mentioned technical problem, the embodiments of the present disclosure adopt the following technical solutions:

In a first aspect, an embodiment of the present disclosure provides a charging system configured to perform dynamic power distribution, where the charging system includes:
at least one group of charging sets, where each charging set includes a master charging pile and a plurality of slave charging piles, and the master charging pile is respectively connected to the plurality of slave charging piles; and
a cloud server, wherein the cloud server is configured to be in a communication connection with the master charging pile in the at least one group of charging sets; where
the master charging pile is connected to a power distribution controller of a power grid and is configured to acquire a power parameter from the power distribution controller, to determine a distributable power for each charging set;
after the master charging pile receives a power distribution instruction, the master charging pile sends a communication connection request to the cloud server;
in response to a first determination that the communication connection succeeds, the master charging pile receives parameter information sent by the cloud server; and calculates to obtain power distribution information for at least one charging pile of the plurality of slave charging piles and the master charging pile according to a dynamic power distribution algorithm, the parameter information and the distributable power; and
in response to a second determination that the communication connection fails, the master charging pile calculates to obtain power distribution information for the at least one charging pile of the plurality of slave charging piles and the master charging pile according to the dynamic power algorithm and the distributable power.

In a second aspect, an embodiment of the present disclosure provides a dynamic power distribution method applied to a charging system, where the charging system includes at least one group of charging sets and a cloud server, the at least one group of charging sets include a master charging pile and a plurality of slave charging piles, and the master charging pile is respectively connected to the plurality of slave charging piles; the cloud server is in a communication connection with the master charging pile, and the master charging pile is connected to a power distribution controller of a power grid; where the method includes:
acquiring a power parameter from a power distribution controller, to determine a distributable power for a charging set;
after a power distribution instruction is received, sending a communication connection request to a cloud server;
in response to a first determination that the communication connection succeeds, receiving parameter information sent by the cloud server; and calculating power distribution information for at least one charging pile of the plurality of slave charging piles and the master charging pile according to a dynamic power distribution algorithm, the parameter information and the distributable power; and
in response to a second determination that the communication connection fails, calculating to obtain power distribution information for the at least one charging pile of the plurality of slave charging piles and the master charging pile according to the dynamic power algorithm and the distributable power.

In a third aspect, an embodiment of the present disclosure provides a dynamic power distribution apparatus for use in a charging system, the apparatus including:
an acquirer configured to acquire a power parameter from the power distribution controller, to determine a distributable power for the charging set;
a requester configured to send, after a power distribution instruction is received, a communication connection request to a cloud server;
a first calculator configured to receive, in response to a first determination that the communication connection succeeds, parameter information which is sent by the cloud server; and calculate to obtain power distribution information for at least one charging pile of a plurality of slave charging piles and a master charging pile according to a dynamic power distribution algorithm, the parameter information and the distributable power; and
a second calculator configured to calculate to obtain, in response to a second determination that the communication connection fails, power distribution information for at least one charging pile of the plurality of slave charging piles and the master charging pile according to the dynamic power algorithm and the distributable power.

In a fourth aspect, an embodiment of the present disclosure provides a master charging pile, including:
at least one processor; and
a memory in a communication connection with the processor, where the memory stores instructions executable by the at least one processor, and the instructions are executable by the at least one processor to cause the at least one processor to perform the acts described in the second aspect.

In a fifth aspect, an embodiment of the present disclosure provides a non-volatile or non-transitory computer-readable storage medium storing computer-executable instructions, wherein when executed by a charging pile, the computer-readable storage medium causes the charging pile apparatus to perform the acts described in the second aspect.

### BRIEF DESCRIPTION OF DRAWINGS

One or more embodiments are illustrated by way of example in the accompanying drawings which correspond to and are not to be construed as limiting the embodiments, in which elements having the same reference numeral designations represent like elements throughout, and in which the drawings are not to be construed as limiting in scale unless otherwise specified.

FIG. 1 is a schematic diagram showing a charging system capable of dynamic power distribution according to an embodiment of the present disclosure;

FIG. 2 is a flow diagram showing a dynamic power distribution method according to an embodiment of the present disclosure;

FIG. 3 is a schematic structural diagram showing a dynamic power distribution apparatus according to an embodiment of the present disclosure;

FIG. 4 is a schematic structural diagram showing a dynamic power distribution apparatus according to another embodiment of the present disclosure; and

FIG. 5 is a schematic structural diagram showing a controller of a master charging pile according to an embodiment of the present disclosure.

### DETAILED DESCRIPTION

The embodiments of the present disclosure provide a charging system capable of dynamic power distribution, and method, apparatus, master charging pile and medium, where the charging system includes at least one group of charging sets, where each charging set includes a master charging pile and a plurality of slave charging piles, and the master charging pile is respectively connected to the plurality of slave charging piles; and a cloud server, where the cloud server is configured to be in a communication connection with the master charging pile in the at least one group of charging sets; and the master charging pile is connected to a power distribution controller of a power grid and is configured to acquire a power parameter from the power distribution controller, to determine a distributable power for the charging set; after the master charging pile receives a power distribution instruction, the master charging pile sends a communication connection request to the cloud server; in response to a first determination that the communication connection succeeds, the master charging pile receives parameter information which is sent by the cloud server; and calculates to obtain power distribution information for at least one charging pile of the plurality of slave charging piles and the master charging pile according to a dynamic power distribution algorithm, the parameter information and the distributable power; and in response to a second determination that the communication connection fails, calculates to obtain power distribution information for at least one charging pile of the plurality of slave charging piles and the master charging pile according to the dynamic power algorithm and the distributable power; that is to say, in a case that the connection between the master charging pile and the cloud server fails, the master charging pile can also calculate power distribution information directly according to the dynamic power algorithm and the distributable power; the charging pile to be used for charging can perform charging based on the power distribution information, and power distribution does not need to be performed by the cloud server; and the master charging pile directly calculates the power distribution information, which can ensure the local information security of charging pile.

The present disclosure will be described in detail with reference to specific embodiments. The following embodiments will aid a person skilled in the art in further understanding the present disclosure, but are not intended to limit the present disclosure in any manner. It should be noted that variations and modifications can be made by a person skilled in the art without departing from the concept of the present disclosure. These are all within the scope of protection of the present disclosure.

In order that the objectives, aspects and advantages of the present disclosure may be more clearly understood, a more particular description of the present disclosure, briefly summarized below, may be had by reference to the appended drawings and embodiments. It should be understood that the particular embodiments described herein are illustrative only and are not restrictive.

It should be noted that, if not in conflict, the various features of the embodiments of the present disclosure may be combined with of the present disclosure. In addition, although the division of functional modules is illustrated in a schematic diagram showing an apparatus and a logical order is illustrated in a flowchart, in some cases, the steps illustrated or described may be performed in an order other than the division of the modules the apparatus or in the flowchart. Moreover, the words “first,” “second,” “third,” and the like, as used herein do not limit the data and order of execution, but merely distinguish the same item or similar item having substantially the same function or action. In some examples, “modules” may refer to “program instructions.”

Unless defined otherwise, all technical and scientific terms used in the description have the same meaning as commonly understood by a person skilled in the art to which the present disclosure belongs. The terminologies used in the description of the present disclosure are for the purpose of describing particular embodiments only and are not intended to be limiting of the present disclosure. As used herein, the term “and/or” includes any and all combinations of one or more of the associated listed items.

Moreover, the technical features involved in the respective embodiments of the present disclosure described below may be combined with each other as long as they do not conflict with each other.

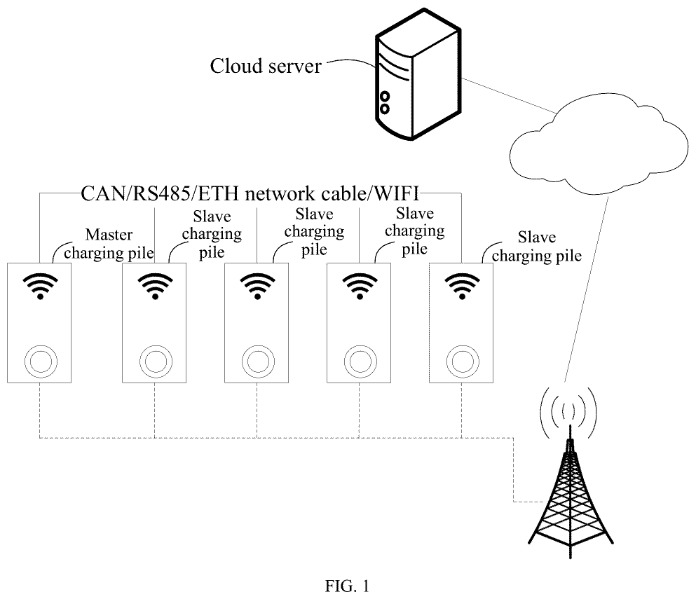

As shown in FIG. 1, a charging system capable of dynamic power distribution according to an embodiment of the present disclosure includes:
at least one group of charging sets, where each charging set includes a master charging pile and a plurality of slave charging piles, and the master charging pile is respectively connected to the plurality of slave charging piles; and
a cloud server, where the cloud server is configured to be in a communication connection with the master charging pile in the at least one group of charging sets.

In at least one group of charging sets in one charging system, the master charging pile is any one charging pile in the charging system, and the slave charging piles are the remaining charging piles in the charging pile system except the master charging pile, and the master charging pile is in communication connection with a plurality of slave charging piles.

In an embodiment, the master charging pile is in communication connection with the slave charging pile via at least one of CAN, RS485, ETH network cable, and WIFI.

Controller Area Network (CAN) is an industrial bus system.

Recommended Standard 485 (RS485) is a bus type communication, which adopts a master-slave communication mode, i.e., a master and a plurality of slaves. In an embodiment of the present disclosure, the master is a master charging pile, and the slaves are slave charging piles.

ETH in the ETH network cable refers to Ethernet, which is a technology.

WIFI is a wireless local area network.

A communication connection between a master charging pile and a plurality of slave charging piles is established through any one of the above-mentioned four local area network modes, so that the master charging pile can locally manage the slave charging piles.

When the cloud server is in communication connection with the master charging pile in at least one group of the charging sets, the master charging pile and/or the slave charging pile are in communication connection with the cloud server, and the communication connection method can be a wide area network method, such as a 5G network, a 4G network and a 3G network, so as to realize the communication connection between the master charging pile and the cloud server; certainly, a local area network method, such as WIFI, can also be used to realize the communication connection between the master charging pile and the cloud server; and after the communication connection between the master charging pile and the cloud server is established, since the master charging pile is in communication connection with the plurality of slave charging piles, the master charging pile and the plurality of slave charging piles are wirelessly connected to the cloud server. Furthermore, a plurality of slave charging piles may be respectively wirelessly connected to the cloud server, which is not limited thereto.

The master charging pile is connected to a power distribution controller of a power grid and is configured to acquire a power parameter from the power distribution controller, to determine a distributable power for the charging set. The power distribution controller of the power grid may be an individual device or may be a charging pile in any charging set, without limitation. The power parameter of the power grid is the total power that can be distributed to the whole power grid where the charging system is located; the power distribution controller of the power grid sends the power parameter of the power grid to the master charging pile, so that the master charging pile can distribute power to each charging pile in the charging sets according to the power parameter, and obtain the distributable power of each charging pile in each charging set.

When the master charging pile receives a power distribution instruction, the master charging pile sends a communication connection request to the cloud server.

When the master charging pile receives the power distribution instruction, first, the master charging pile sends a communication connection request to the cloud server. The power distribution instruction refers to when a certain charging pile needs to charge an electric vehicle, the charging pile is triggered to generate a power distribution instruction, and the power distribution instruction is sent to the master charging pile so that the master charging pile obtains the power distribution instruction; and the charging pile can be either the master charging pile or the slave charging pile, both of which can be used as a charging pile that an electric vehicle to be charged may connect to perform charging, and therefore the charging pile needs to perform charging power distribution.
in response to a first determination that the communication connection succeeds, the master charging pile receives parameter information which is sent by the cloud server; and calculates to obtain power distribution information for at least one charging pile of a plurality of slave charging piles and a master charging pile according to a dynamic power distribution algorithm, the parameter information and the distributable power.

In an embodiment, when the communication connection between the master charging pile and the cloud server is established, i.e., the master charging pile is in a networked state with the cloud server, parameter information is downloaded from the cloud server, and the parameter information may include priority information and electricity price information about the charging set. The priority information about the charging sets includes a priority order among various charging piles in the at least one group of charging sets, for example, a charging pile with a higher priority is distributed to more grid power than a charging pile with a lower priority is distributed to grid power, and the electricity price information includes electricity price information about an area where the charging system is located, and generally includes a civil electricity price and a commercial electricity price.

When the master charging pile is in a networked state with the cloud server, the master charging pile downloads parameter information from the cloud server, and then the master charging pile calculates power distribution information for at least one of the plurality of slave charging piles and the master charging pile according to a dynamic power distribution algorithm, the parameter information and the distributable power; therefore, if the parameter information is updated by the cloud server, an algorithm for the power distribution information can be updated.

In response to a second determination that the communication connection fails, the master charging pile calculates to obtain power distribution information for at least one of the plurality of slave charging piles and the master charging pile according to the dynamic power algorithm and the distributable power.

In an embodiment, when the master charging pile receives the power distribution instruction, if the communication connection between the master charging pile and the cloud server is disconnected, i.e., the network between the master charging pile and the cloud server is disconnected, for example, a fault occurs, at this moment, the master charging pile calculates to obtain power distribution information according to the dynamic power algorithm and the distributable power, and the cloud server is not required to calculate the power distribution information; therefore, the cloud server is avoided to be a security hidden danger when calculating the power distribution information, the local information security of the charging pile is effectively ensured, and the local stability and reliability of the charging pile system are improved.

In an embodiment of the present disclosure, when the master charging pile receives a power distribution instruction, the master charging pile sends a communication connection request to the cloud server; if the communication connection succeeds, receiving parameter information which is sent by the cloud server; and calculating power distribution information for at least one of a plurality of slave charging piles and a master charging pile according to a dynamic power distribution algorithm, the parameter information and the distributable power; and if the communication connection fails, calculating power distribution information for at least one of the plurality of slave charging piles and the master charging pile according to the dynamic power algorithm and the distributable power; that is to say, in a case that the connection between the master charging pile and the cloud server fails, the master charging pile can also calculate power distribution information directly according to the dynamic power algorithm and the distributable power; the charging pile to be used for charging can perform charging based on the power distribution information, and power distribution does not need to be performed by the cloud server; and the master charging pile directly calculates the power distribution information, which can ensure the local information security of charging pile.

The dynamic power distribution method and apparatus provided by an embodiment of the present disclosure can be applied to a charging system, and it can be understood that the charging system includes at least one group of charging pile and a cloud server, the charging sets include a master charging pile and a plurality of slave charging piles, and the master charging pile is respectively connected to the plurality of slave charging piles; the cloud server is in communication connection with the master charging pile, and the master charging pile is connected to a power distribution controller of a power grid. With the controller of the master charging pile is used a master control center, the problem of it not being possible to calculate a charging power in the case of network disconnection can be avoided; moreover, a configuration can be updated when a network is connected.

Referring to FIG. 2, a flow diagram showing a dynamic power distribution method of the present disclosure, the method may be performed by a controller of a master charging pile of a charging system, and the method includes steps S101-S104.

S101: acquiring a power parameter from a power distribution controller, to determine a distributable power for a charging set.

In an embodiment, the power parameter of the power grid is the total power that can be distributed to the whole power grid where the charging system is located; the power distribution controller of the power grid sends the power parameter of the power grid to the master charging pile, so that the master charging pile can distribute power to each charging pile in the charging sets according to the power parameter, and obtain the distributable power of each charging pile in each charging set.

S102: after a power distribution instruction is received, sending a communication connection request to a cloud server.

S103: in response to a first determination that the communication connection succeeds, receiving parameter information which is sent by the cloud server; and calculating to obtain power distribution information for at least one charging pile of a plurality of slave charging piles and a master charging pile according to a dynamic power distribution algorithm, the parameter information and the distributable power.

In an embodiment, when the communication connection between the master charging pile and the cloud server is established, i.e., the master charging pile is in a networked state with the cloud server, parameter information is downloaded from the cloud server, and the parameter information may include priority information and electricity price information about the charging set. The priority information about the charging sets includes a priority order among various charging piles in the at least one group of charging sets, for example, a charging pile with a higher priority is distributed to more grid power than a charging pile with a lower priority is distributed to grid power, and the electricity price information includes electricity price information about an area where the charging system is located, and generally includes a civil electricity price and a commercial electricity price.

It can be understood that when the master charging pile receives the power distribution instruction, if the communication connection between the master charging pile and the cloud server is established, the master charging pile still calculates to obtain the power distribution information, and the cloud server is not required to calculate to obtain the power distribution information.

S104: calculating to obtain power distribution information for at least one charging pile of the plurality of slave charging piles and the master charging pile according to the dynamic power distribution algorithm and the distributable power.

In an embodiment, when the master charging pile receives the power distribution instruction, if the communication connection between the master charging pile and the cloud server is disconnected, i.e., the network between the master charging pile and the cloud server is disconnected, for example, a fault occurs, at this moment, the master charging pile calculates to obtain power distribution information according to the dynamic power algorithm and the distributable power, and the cloud server is not required to calculate the power distribution information; therefore, the cloud server is avoided to be a security hidden danger when calculating the power distribution information, the local information security of the charging pile is effectively ensured, and the local stability and reliability of the charging pile system are improved.

In an embodiment, in response to a third determination that the charging pile to be distributed power is a master charging pile, the master charging pile performs a charging operation for an electric vehicle to be charged according to the power distribution information.
in response to a fourth determination that the charging pile to be used for charging is a slave charging pile, the master charging pile sends the power distribution information to the slave charging pile to be used for charging, so that after obtaining the power distribution information, the slave charging pile to be used for charging can perform a charging operation on the electric vehicle to be charged based on the power distribution information, thereby realizing the distribution of grid power and the charging of the electric vehicle.

In some embodiments, in order to enable the cloud server to summarize data information corresponding to the charging system, the method may further include:

in response to a first determination that the communication connection succeeds, sending charging pile data information to the cloud server, where the charging pile data information includes data information about the master charging pile and/or data information about the slave charging pile.

In an embodiment, the master charging pile can summarize data of each charging pile in the charging pile system to obtain charging pile data information, and then, when the communication connection between the master charging pile and the cloud server succeeds, the charging pile data information is sent to the cloud server to realize centralized reporting of the charging pile data and improve reporting efficiency. The reliability of the local communication algorithm of the charging pile system can be effectively exerted, and at the same time, when the communication connection between the master charging pile and the cloud server is established, the ability of updating the algorithm can be scheduled in real time.

In an embodiment of the present disclosure, when the master charging pile receives a power distribution instruction, the master charging pile sends a communication connection request to the cloud server; in response to a first determination that the communication connection succeeds, receiving parameter information which is sent by the cloud server; and calculating to obtain power distribution information for at least one of a plurality of slave charging piles and a master charging pile according to a dynamic power distribution algorithm, the parameter information and the distributable power; and in response to a second determination that the communication connection fails, calculating to obtain power distribution information for at least one of the plurality of slave charging piles and the master charging pile according to the dynamic power algorithm and the distributable power; that is to say, in a case that the connection between the master charging pile and the cloud server fails, the master charging pile can also calculate to obtain power distribution information directly according to the dynamic power algorithm and the distributable power; the charging pile to be used for charging can perform charging based on the power distribution information, and power distribution does not need to be performed by the cloud server; and the master charging pile directly calculates to obtain the power distribution information, which can ensure the local information security of charging pile.

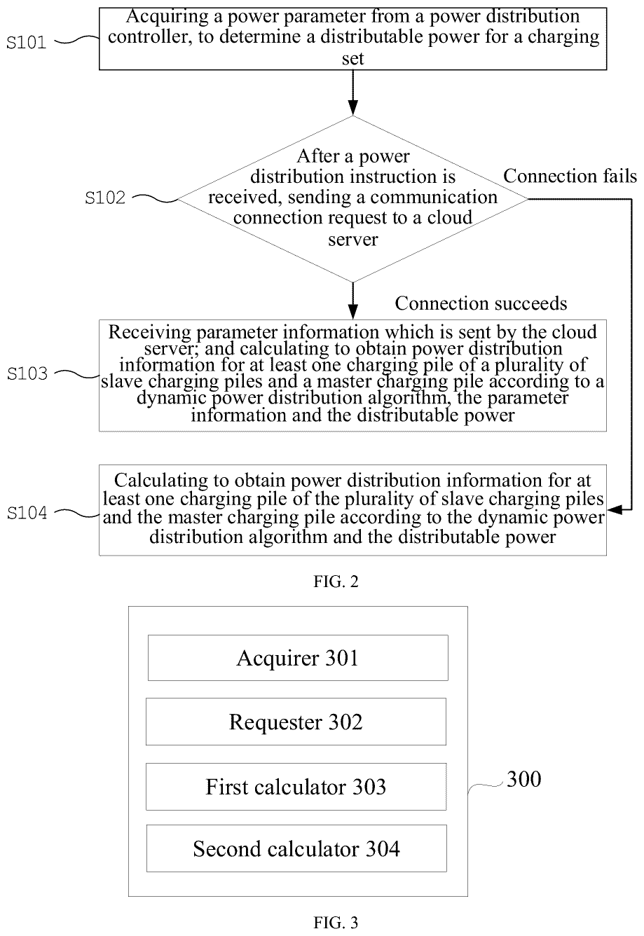

An embodiment of the present disclosure also provides a dynamic power distribution apparatus. With reference to FIG. 3, the structure of a dynamic power distribution apparatus provided by an embodiment of the present disclosure is shown, and the dynamic power distribution apparatus 300 includes:
an acquirer 301 configured to acquire a power parameter from the power distribution controller, to determine a distributable power for the charging set;
a requester 302 configured to send, after a power distribution instruction is received, a communication connection request to a cloud server;
a first calculator 303 configured to receive, in response to a first determination that the communication connection succeeds, parameter information which is sent by the cloud server; and calculate to obtain power distribution information for at least one of a plurality of slave charging piles and a master charging pile according to a dynamic power distribution algorithm, the parameter information and the distributable power; and
a second calculator 304 configured to calculate to obtain, in response to a second determination that the communication connection fails, power distribution information for at least one of the plurality of slave charging piles and the master charging pile according to the dynamic power algorithm and the distributable power.

In an embodiment of the present disclosure, when the master charging pile receives a power distribution instruction, the master charging pile sends a communication connection request to the cloud server; in response to a first determination that the communication connection succeeds, receiving parameter information which is sent by the cloud server; and calculating to obtain power distribution information for at least one of a plurality of slave charging piles and a master charging pile according to a dynamic power distribution algorithm, the parameter information and the distributable power; and in response to a second determination that the communication connection fails, calculating to obtain power distribution information for at least one of the plurality of slave charging piles and the master charging pile according to the dynamic power algorithm and the distributable power; that is to say, in a case that the connection between the master charging pile and the cloud server fails, the master charging pile can also calculate to obtain power distribution information directly according to the dynamic power algorithm and the distributable power; the charging pile to be used for charging can perform charging based on the power distribution information, and power distribution does not need to be performed by the cloud server; and the master charging pile directly calculates to obtain the power distribution information, which can ensure the local information security of charging pile.

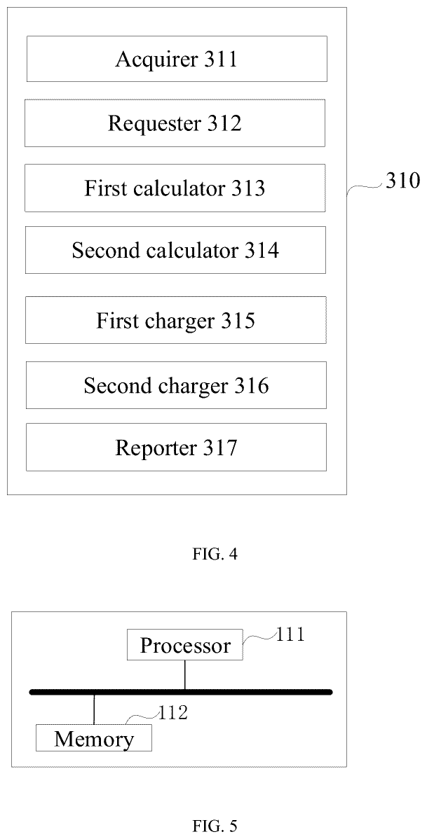

In some embodiments, as shown in FIG. 4, a dynamic power distribution apparatus 310 further includes a first charging module 315 configured to,
in response to a third determination that the charging pile to be used for charging is the master charging pile, charge an electric vehicle to be charged according to the power distribution information.

In some embodiments, the dynamic power distribution apparatus 310 further includes a second charging module 316 configured to,
in response to a fourth determination that the charging pile to be used for charging is the slave charging pile, then send the power distribution information to the slave charging pile to be used for charging.

In some embodiments, the dynamic power distribution apparatus 310 further includes a reporting module 317 further configured to:
in response to a first determination that the communication connection succeeds, send charging pile data information to the cloud server, where the charging pile data information includes data information about the master charging pile and/or data information about the slave charging pile.

It should be noted that the above-mentioned apparatus can execute the groove depth measurement method provided by an embodiment of the present disclosure, and has functional modules and advantageous effects corresponding to the execution method. For technical details that are not described in detail in the apparatus embodiments, reference may be made to the method provided by an embodiment of the present disclosure.

FIG. 5 is a schematic structural diagram showing a hardware of the controller in one embodiment of the master charging pile, and as shown in FIG. 5, the controller includes:
one or more processors 111, and a memory 112. In FIG. 5, a processor 111 and a memory 112 are exemplified.

The processors 111 and the memory 112 may be connected via a bus or in other ways, and via a bus connection exemplified in FIG. 5.

The memory 112, as a non-volatile computer-readable storage medium, can be used for storing a non-volatile software program, a non-volatile computer-executable program and modules, such as program instructions or modules corresponding to the dynamic power distribution method in the embodiment of the present disclosure (for example, an acquirer 311, a requester 312, a first calculator 313, a second calculator 314, a first charging module 315, a second charging module 316 and a reporting module 317 shown in FIG. 4). The processor 111 executes various functional applications of the controller and data processing by running non-volatile software programs, instructions and modules stored in the memory 112, i.e. implementing the dynamic power distribution method of the above-described method embodiments.

The memory 112 may include a program storage area and a data storage area, where the program storage area may store an operating system, an application program required for at least one function; the data storage area may store data created according to use of the person entry and exit detecting apparatus, and the like. Moreover, the memory 112 may include high speed random access memory, and may also include non-volatile memory, such as at least one magnetic disk storage device, flash memory device, or other non-volatile solid state storage device. In some embodiments, the memory 112 may optionally include memory located remotely from the processor 111, which may be connected to the charging pile via a network. Embodiments of such networks include, but are not limited to, the Internet, Intranets, local area networks, mobile communication networks, and combinations thereof.

The one or more modules are stored in the memory 112, and when executed by the one or more processors 111, perform the dynamic power distribution method in any of the above-mentioned method embodiments, for example, perform the above-described method steps S101 to S104 in FIG. 2; the functions of components 301-304 in FIGS. 3, and 311-317 in FIG. 4 are implemented.

The above-mentioned product can execute the groove depth measurement method provided by an embodiment of the present disclosure, and has functional modules and advantageous effects corresponding to the execution method. For technical details that are not described in detail in this embodiment, reference may be made to the method provided by an embodiment of the present disclosure.

Embodiments of the present disclosure provide a non-volatile computer-readable storage medium having stored thereon computer-executable instructions that, when executed by one or more processors, such as processor 111 of FIG. 5, may cause the one or more processors to perform the dynamic power distribution method in any of the method embodiments described above, such as by performing method steps S101 through S104 of FIG. 2 described above; the functions of modules 301-304 in FIGS. 3, and 311-317 in FIG. 4 are implemented.

The above-described embodiments of the apparatus are merely illustrative, and the units described as separate parts may or may not be physically separate, and parts displayed as units may or may not be physical units, may be located in one position, or may be distributed on multiple network units. Some or all the modules may be selected according to actual needs to achieve the purpose of the solution of this embodiment.

Through the above description of the embodiments, it is clear to a person skilled in the art that the embodiments may be implemented by software plus a general hardware platform, and may also be implemented by hardware. A person skilled in the art will appreciate that all or part of the processes in the methods of the embodiments described above can be implemented by hardware related to instructions of a computer program, and the computer program can be stored in a computer readable storage medium, and when executed, the computer program can include the processes of the embodiments of the methods described above. The storage medium may be a magnetic disk, a compact disk, a Read-Only Memory (ROM) or a Random Access Memory (RAM), etc.

The above description is only for the specific embodiments of the present disclosure, but the scope of the present disclosure is not limited thereto, and any person skilled in the art can easily think of the changes or substitutions within the technical scope of the present disclosure, and shall cover the scope of the present disclosure. Therefore, the scope of protection of this application should be determined by the scope of the claims.

What is claimed is:

1. A charging system configured to perform dynamic power distribution, the charging system comprising:
at least one group of charging sets, wherein each charging set comprises a master charging pile and a plurality of slave charging piles, and the master charging pile is respectively connected to the plurality of slave charging piles; and
a cloud server, wherein the cloud server is configured to be in a communication connection with the master charging pile in the at least one group of charging sets; wherein
the master charging pile is connected to a power distribution controller of a power grid and is configured to acquire a power parameter from the power distribution controller, to determine a distributable power for each charging set;
after the master charging pile receives a power distribution instruction, the master charging pile sends a communication connection request to the cloud server;
in response to a first determination that the communication connection succeeds, the master charging pile receives parameter information sent by the cloud server; and calculates to obtain power distribution information for at least one charging pile of the plurality of slave charging piles and the master charging pile according to a dynamic power distribution algorithm, the parameter information, and the distributable power; and
in response to a second determination that the communication connection fails, the master charging pile calculates to obtain power distribution information for the at least one charging pile of the plurality of slave charging piles and the master charging pile according to the dynamic power algorithm and the distributable power.

2. The charging system according to claim 1, wherein the master charging pile is in communication connection with the plurality of slave charging piles via at least one of Controller Area Network (CAN), Recommended Standard 485 (RS485), Ethernet (ETH) network cable, or WIFI.

3. The charging system according to claim 1, wherein the parameter information comprises priority information and electricity price information of each charging set.

4. A dynamic power distribution method applied to a charging system, wherein the charging system comprises at least one group of charging sets and a cloud server, the at least one group of charging sets comprise a master charging pile and a plurality of slave charging piles, and the master charging pile is respectively connected to the plurality of slave charging piles; the cloud server is in a communication connection with the master charging pile, and the master charging pile is connected to a power distribution controller of a power grid; wherein the method comprises:
acquiring a power parameter from the power distribution controller, to determine a distributable power for a charging set;
after a power distribution instruction is received, sending a communication connection request to the cloud server;
in response to a first determination that the communication connection succeeds, receiving parameter information sent by the cloud server; and calculating to obtain power distribution information for at least one charging pile of the plurality of slave charging piles and the master charging pile according to a dynamic power distribution algorithm, the parameter information, and the distributable power; and
in response to a second determination that the communication connection fails, calculating to obtain power distribution information for the at least one charging pile of the plurality of slave charging piles and the master charging pile according to the dynamic power algorithm and the distributable power.

5. The method according to claim 4, further comprising:
in response to a third determination that a charging pile to be used for charging is the master charging pile, charging an electric vehicle to be charged according to the power distribution information.

6. The method according to claim 4, further comprising:
in response to a fourth determination that a charging pile to be used for charging is a slave charging pile, sending the power distribution information to the slave charging pile to be used for charging.

7. The method according to claim 4, further comprising:
in response to a first determination that the communication connection succeeds, sending charging pile data information to the cloud server, wherein the charging pile data information comprises at least one of data information about the master charging pile or data information about the plurality of slave charging piles.

8. A master charging pile, comprising:
at least one processor; and
a memory in a communication connection with the processor, wherein the memory stores instructions executable by the at least one processor, and the instructions, when executed by the at least one processor, causes the at least one processor to perform acts comprising:
acquiring a power parameter from a power distribution controller, to determine a distributable power for a charging set;
after a power distribution instruction is received, sending a communication connection request to a cloud server;
in response to a first determination that the communication connection succeeds, receiving parameter information sent by the cloud server; and calculating to obtain power distribution information for at least one charging pile of a plurality of slave charging piles and the master charging pile according to a dynamic power distribution algorithm, the parameter information, and the distributable power; and
in response to a second determination that the communication connection fails, calculating to obtain power distribution information for the at least one charging pile of the plurality of slave charging piles and the master charging pile according to the dynamic power algorithm and the distributable power.
